(19) United States
(12) Patent Application Publication
(10) Pub. No.: US 2006/0164802 A1
(43) Pub. Date: Jul. 27, 2006

(54) Portable computer enclosure

(75) Inventor: Hsuan-Chen Chen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/317,449

(22) Filed: Dec. 23, 2005

(30) Foreign Application Priority Data
Jan. 21, 2005 (CN) 200520054224.7

(51) Int. Cl. G06F 1/16

(52) U.S. Cl. 361/683

(57) ABSTRACT

A portable computer enclosure includes a base unit (10), a pair of slide rails (50), a side panel (30) and a cover unit (20). The base unit includes a bottom panel (11) and two side walls (13). The slide rails are slidably attached to the bottom panel of the base unit. The side panel is pivotally attached to the slide rails and locked on the side walls of the base unit. The cover unit is pivotally connected to a rear portion of the base unit.

### BACKGROUND OF THE INVENTION

1. Field of the Invention

The present invention relates to a portable computer enclosure, and more particularly to a portable computer enclosure which includes a closed side panel to prevent dust.

2. General Background

Portable computers, such as laptop computers and notebook computers, have become increasingly popular for general use. Generally, a portable computer enclosure includes a cover unit and a base unit formed side panels. A plurality of openings of removable storage devices or interfaces of connecters is formed on one or more of the side panels. However, the openings and interfaces are exposed to the open air so that dust come into the base unit easily, hence the internal components of the portable computer are easily contaminated and become damaged.

What is desired, therefore, is a portable computer enclosure which has a closed side panel to prevent dust.

### SUMMARY

In one preferred embodiment, a portable computer enclosure includes a base unit, a pair of slide rails, a side panel and a cover unit. The base unit includes a bottom panel and two side walls. The slide rails are slidably attached to the bottom panel of the base unit. The side panel is pivotally attached to the slide rails and locked on the side walls of the base unit. The cover unit is pivotally connected to a rear portion of the base unit.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of a portable computer enclosure with a side panel in accordance with preferred embodiment of the present invention, in which a top panel is not shown;

FIG. 2 is an enlarged isometric view of an encircled portion II of FIG. 1;

FIG. 3 is an assembled view of FIG. 2;

FIG. 4 is an enlarged isometric view of the side panel and a pair of slide rails of FIG. 1; and

FIGS. 5 and 6 are assembled views of FIG. 1, respectively schematically showing the side panel in different working states.

### DETAILED DESCRIPTION OF THE EMBODIMENT

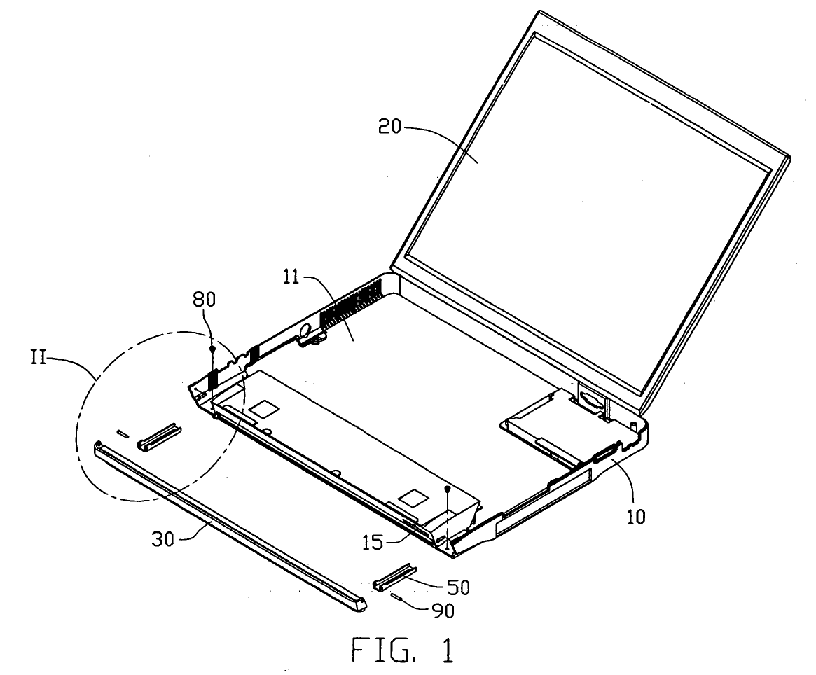

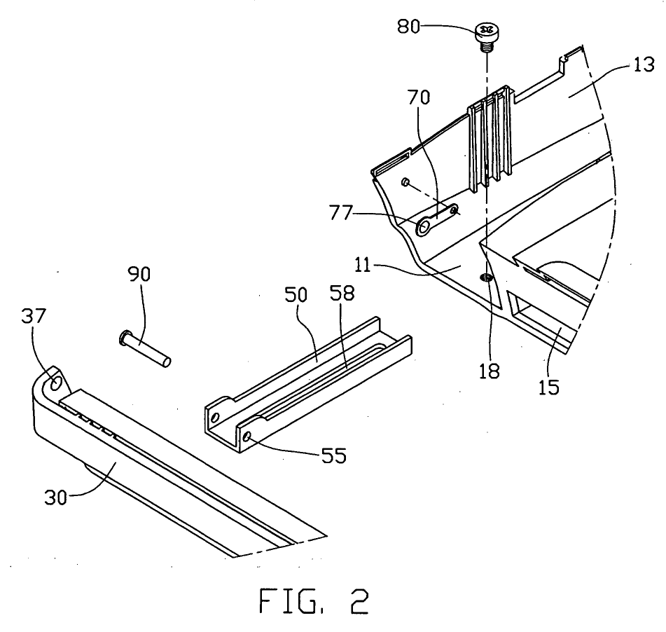

Referring to FIGS. 1 and 2, an enclosure of an electronic apparatus like a portable computer includes a base unit 10, a cover unit 20 pivotally connected to a rear portion of the base unit 10, a side panel 30, a pair of slide rails 50 connected between the base unit 10 and the side panel 30, a pair of resilient members 70, and a pair of screws 80.

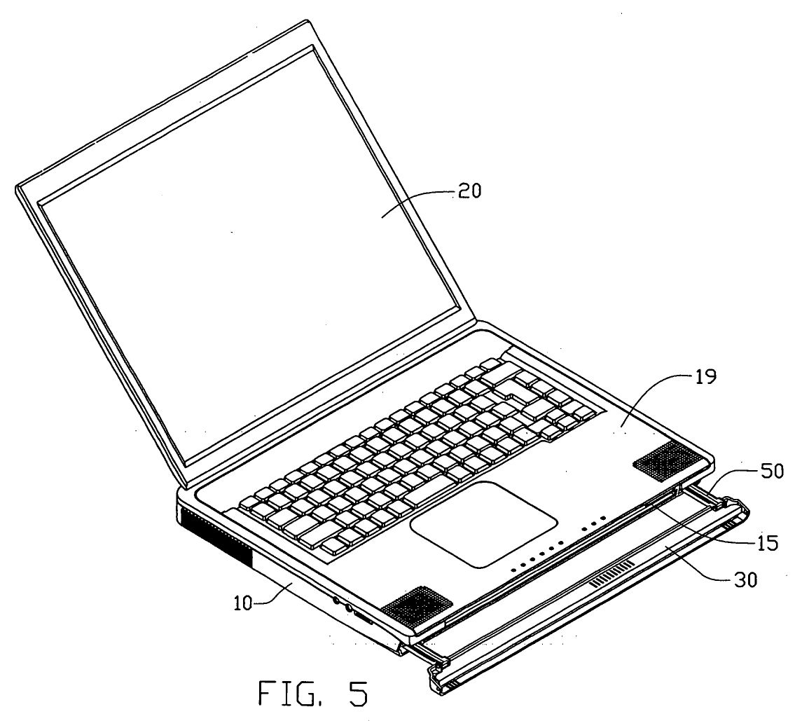

The base unit 10 includes a bottom panel 11, two side walls 13 extending from a pair of opposite edges of the bottom panel 11, and a top panel 19 (shown in FIG. 5). A plurality of interfaces 15 of connecters and openings of removable storage devices are arranged in the base unit 10. A pair of threaded holes 18 is defined in the bottom panel 11 adjacent the side walls 13, respectively. The top panel 19 is placed on the side walls 13.

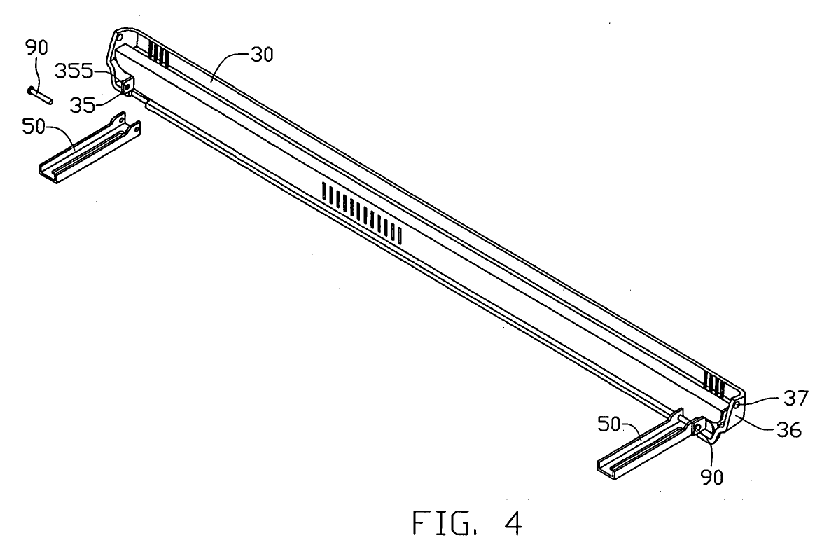

As shown in FIG. 4, a pair of connecting members 35 is formed at an internal side of the side panel 30 adjacent a bottom edge of the side panel 30. Each connecting member 35 defines a pivot hole 355. A pair of side plates 36 extends from opposite ends of the side panel 30, and each side plate 36 defines a through hole 37.

Referring back to FIG. 2, each slide rail 50 defines a pair of pivot holes 55 at an end thereof adjacent the side panel 30 corresponding to the pivot hole 355. A slideway 58 is formed in each slide rail 50 corresponding to the threaded hole 18 of the base unit 10. Two shafts 90 are provided to attach the slide rails 50 to the side panel 30 respectively.

The resilient members 70 are secured to the side walls 13 of the base unit 10. A free end of each resilient member 70 extends towards the side panel 30. A locking portion 77 protrudes from the free end of each resilient member 70 corresponding to the through hole 37 of the side panel 30.

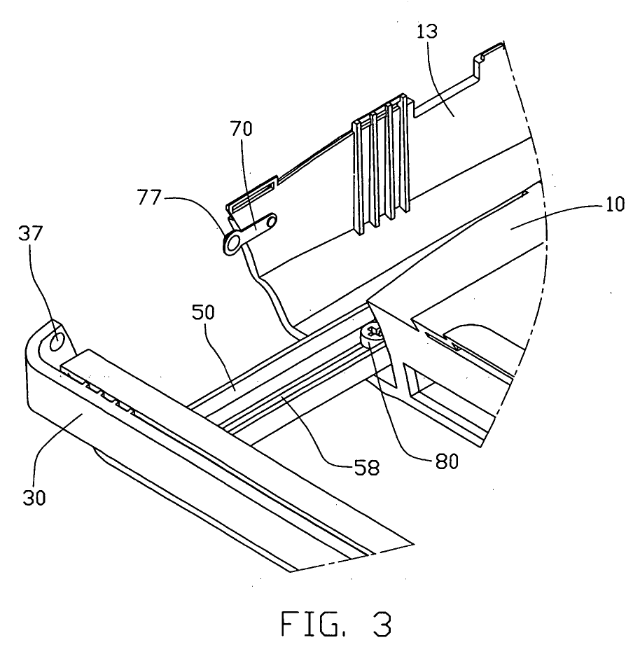

As shown in FIGS. 3 and 4, in assembly, the shafts 90 extend through the pivot holes 355 of the side panel 30 and the pivot holes 55 of the slide rails 50 to pivotally attach the slide rails 50 to the side panel 30. The slide rails 50 are slidably attached to the base unit 10 with the screws 80 extending through the slideways 58 and then engaging in the threaded holes 18 respectively. The top panel 19 is then assembled with the side walls 13, and the cover unit 20 is pivotally connected to a rear portion of the base unit 10 to form the portable computer enclosure. The assembled view of the portable computer enclosure is shown in FIG. 5.

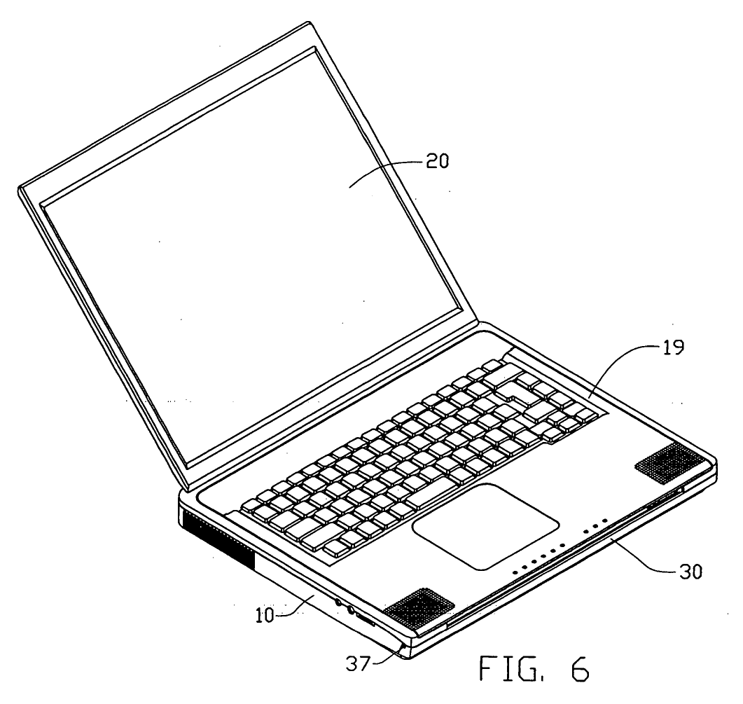

A plurality of connecters is arranged as the interfaces 15 of the base unit 10 accompanying with opening for removable storage devices. To close the side panel 30, the side panel 30 is pushed toward the base unit 10 and drives the slideways 50 to move along the screws 80 into the base unit 10. When the bottom edge of the side panel 30 is stopped by the bottom panel 11 of the base unit 10, the side panel 30 rotates around the shafts 90 until the through holes 37 are locked by the locking portions 77 of the resilient members 70. The assembled view of the portable computer enclosure is shown in FIG. 6.

To pull out or replace one or more of removable devices, the locking portions 77 of the resilient members 70 are pressed toward each other, the through holes 37 of the side panel 30 are released. The side panel 30 is pulled out. When the side panel 30 are pulled away from the base unit 10, the side panel 30 rotates around the shafts 90, and the slide rails 50 are driven to move along the screws 80 until the slideways 58 are stopped by the screws 80. The removable devices can be pulled out freely.

In other embodiments, the slide rails 50 are omitted and the side panel 30 are assembled on the base unit 10 pivotally by pivot holes and pivot axes, or there is only one slide rail 50 slidably attached to the base unit 10 with two or more screws 80 extending through the slideway 58, or the screws 80 and the threaded holes 18 are replaced by a pair of slide channels for the slide rails 50 to move along. In addition, the side panel 30 can also be applied to the other sides of the base unit 10 to prevent dust.

It is believed that the present embodiments and their advantages will be understood from the foregoing description, and they will be apparent that various changes may be made thereto without departing from the spirit and scope of the invention or sacrificing all of their material advantages, the examples hereinbefore described merely being preferred or exemplary embodiments.

What is claimed is:

1. A portable computer enclosure comprising:
a base unit comprising a bottom panel and two side walls;
a pair of slide rails slidably attached to the base unit; and
a side panel pivotally attached to the slide rails and locked on the side walls of the base unit.

2. The portable computer enclosure as claimed in claim 1, wherein each of the slide rails comprises a pivot hole, each of opposite ends of the side panel defines a pivot hole, and a shaft extends through the pivot hole of the side panel and the pivot hole of the corresponding slide rail, thereby the side panel is pivotally attached to the slide rails.

3. The portable computer enclosure as claimed in claim 1, wherein each of the slide rails defines a slideway therein, a pair of threaded holes is defined in the bottom panel of the base unit corresponding to the slideways, a pair of screws extends through the slideways and then engages in the threaded holes respectively to slidably attach the slide rails to the base unit.

4. The portable computer enclosure as claimed in claim 1, wherein a pair of resilient members is respectively secured to the side walls of the base unit, a locking portion protrudes outwardly from a free end of each of the resilient members, and a pair of through holes is defined in opposite ends of the side panel for engagingly receiving the locking portions of the resilient members, respectively.

5. The portable computer enclosure as claimed in claim 1, wherein the base unit comprises a top panel placed on the side walls of the base unit.

6. The portable computer enclosure as claimed in claim 1, wherein the base unit comprises an interface of connecters, and the side panel covers or exposes the interface.

7. The portable computer enclosure as claimed in claim 1, further comprising a cover unit, wherein the cover unit is pivotally connected to a rear portion of the base unit.

8. A portable computer enclosure comprising:
a base unit comprising an interface;
a side panel attached to the base unit and pivotable relative to the base unit between a first position in which the side panel is secured to the base unit and covers the interface, and a second position in which the side panel is released from the base unit and exposes the interface; and
a cover unit pivotally connected to a rear portion of the base unit.

9. The portable computer enclosure as claimed in claim 8, wherein the base unit comprises two side walls, and a pair of resilient members is respectively secured to the side walls of the base unit for locking the side panel.

10. The portable computer enclosure as claimed in claim 9, wherein a locking portion protrudes outwardly from a free end of each of the resilient members, and a pair of through holes is defined in opposite ends of the side panel for engagingly receiving the locking portions of the resilient members, respectively.

11. The portable computer enclosure as claimed in claim 8, further comprising a pair of slide rails, wherein the base unit comprises a bottom panel, and the slide rails are slidably attached to the bottom panel of the base unit.

12. The portable computer enclosure as claimed in claim 11, wherein each of the slide rails defines a slideway therein, a pair of threaded holes is defined in the bottom panel of the base unit corresponding to the slideways, a pair of screws extends through the slideways and then engages in the threaded holes respectively to slidably attach the slide rails to the base unit.

13. The portable computer enclosure as claimed in claim 11, wherein each of the slide rails comprises a pair of pivot holes, each of opposite ends of the side panel defines a pivot hole, and a shaft extends through the pivot hole of the side panel and the pivot holes of the corresponding slide rail, thereby the side panel is pivotally attached to the slide rails.

14. The portable computer enclosure as claimed in claim 8, wherein the base unit comprises a top panel placed on the side walls of the base unit.

15. An electronic apparatus comprising:
an enclosure of said electronic apparatus defining a space therein for receiving, an interface defined along a side of said enclosure so as to allow removable devices installable into said space and removable out of said space via said interface along a predetermined path; and
a side panel removably attachable to said side of said enclosure in order to completely cover said interface, said side panel movable between a first position thereof where said side panel is attached to said side of said enclosure for covering and a second position thereof where said side panel moves aside to avoid interference in said path for installation and removal of said devices.

16. The electronic apparatus as claimed in claim 15, wherein said side panel is pivotally connected to a selective one of said side of said enclosure and a pair of rails installable to said side of said enclosure to guidably slide along said path.
